(19) United States
(12) Patent Application Publication
(10) Pub. No.: US 2011/0067680 A1
(43) Pub. Date: Mar. 24, 2011

(54) Turbocharger and Air Induction System Incorporating the Same and Method of Making and Using the Same

(75) Inventors: Carnell E. Williams, Pontiac, MI (US); Ronald M. Tkac, Brighton, MI (US)

(73) Assignee: GM GLOBAL TECHNOLOGY OPERATIONS, INC., Detroit, MI (US)

(21) Appl. No.: 12/564,259

(22) Filed: Sep. 22, 2009

(51) Int. Cl. F02B 47/08; F02B 33/44

(52) U.S. Cl. 123/568.21; 60/605.2

(57) ABSTRACT

A turbocharger for an internal combustion engine includes a turbine comprising a turbine wheel attached to a turbine shaft, the turbine wheel and shaft rotatably disposed in a turbine housing, the turbine housing comprising a turbine volute conduit, the turbine volute conduit having a turbine volute inlet and an EGR conduit inlet, the EGR conduit inlet radially spaced from the turbine volute inlet along the turbine volute conduit and opening into an EGR conduit that is joined to the turbine volute conduit. The turbine volute inlet is configured for fluid communication of an exhaust gas received from an engine to the turbine wheel, the EGR conduit configured for fluid communication of the exhaust gas to an engine intake conduit. The turbocharger also includes a compressor comprising a compressor wheel attached to the turbine shaft, the compressor wheel and turbine shaft rotatably disposed in compressor housing.

### FIELD OF THE INVENTION

Exemplary embodiments of the present invention are related to a turbine housing and turbocharger incorporating the same, as well as a method of using the same, and, more specifically, to a turbine housing having an integral wastegate/exhaust gas recirculation (EGR) outlet, and turbocharger incorporating the same, as well as a method of using the same.

### BACKGROUND

The efficient use of exhaust gas recirculation (EGR) is very important to all modern internal combustion engines, including both gasoline and diesel engines. Efficient use of EGR generally supports the objectives of realizing high power output from these engines while also achieving high fuel efficiency and economy, and achieving increasingly stringent engine emission requirements. The use of forced-induction, particularly including turbochargers, in these engines is also frequently employed to increase the engine intake mass airflow and the power output of the engine. However, turbochargers are also powered by exhaust gas, so the efficient use of EGR and turbocharged forced-induction necessitates synergistic design of these systems.

Turbocharged diesel engines must be particularly efficient in the use of the energy available in EGR and exhaust gas flows in order to improve overall engine efficiency and fuel economy. Diesel EGR systems are required to deliver high volumes of EGR to the intake air system of the engine. In order to do so, the EGR system must provide enough pressure change through the system, including the flow control valve, bypass valve and cooler to drive the desired EGR flow into the boosted intake system. The exhaust system must also provide adequate exhaust gas energy so that the turbine has sufficient power to provide the desired boost. Typical diesel engine EGR systems feed EGR passages off various exhaust system components. EGR feed passages off the turbine housing have been proposed; however, such EGR feed passages have generally been at less than optimal angles to the desired gas flow direction within the turbine volute, through the use of elbows and the like, thereby creating high flow losses and low efficiency, thereby reducing the amount of EGR flow available for use in the air intake system. Such arrangements do not provide a sufficient volume of intake EGR.

In U.S. Pat. No. 6,430,929, a design has been proposed to associate an EGR outlet with a turbine volute and EGR valve. This design locates the EGR outlet tangentially to the volute and substantially linearly along the flowstream entering the turbine housing inlet. Thus, the EGR outlet is located at the volute inlet and the EGR outlet appears to define the volute inlet. The turbocharger described in this patent incorporates an EGR valve having a flanged elbow, where the hole pattern on the flange can be adjusted to orient the elbow to accommodate varying engine arrangements. The use of the elbow may also be necessitated by the in-line or linear arrangement of the EGR outlet and turbine inlet. However, use of the elbow configuration has an efficiency loss associated therewith. The turbocharger of the '929 patent also incorporates a variable geometry nozzle that is used to increase back pressure in the EGR system. While potentially useful, the costs of variable nozzle turbochargers are significantly higher than those having fixed nozzles. Further, increases in back pressure observed by closing the turbine vanes of a variable nozzle are nearly outweighed by the resultant increase in boost pressure of the intake air, such that the desired increases in EGR flow in the induction system are not achievable.

Accordingly, it is desirable to provide turbine housings, turbochargers and intake air systems that use them and associated methods of use that enhance EGR available for use in the induction system while at the same time providing sufficient exhaust gas flow to drive the turbine and generate the desired pressure boost and air induction into the air intake system, regardless of whether the turbochargers use either fixed or variable nozzle turbines.

### SUMMARY OF THE INVENTION

In accordance with an exemplary embodiment of the present invention, a turbocharger for an internal combustion engine is provided, including a turbine comprising a turbine wheel attached to a turbine shaft, the turbine wheel and shaft rotatably disposed in a turbine housing, the turbine housing comprising a turbine volute conduit, the turbine volute conduit having a turbine volute inlet and a wastegate/EGR conduit inlet, the wastegate/EGR conduit inlet radially spaced from the turbine volute inlet along the turbine volute conduit and opening into an EGR conduit that is joined to the turbine volute conduit. The turbine volute inlet is configured for fluid communication of an exhaust gas received from an engine to the turbine wheel, the EGR conduit configured for fluid communication of the exhaust gas to an engine intake conduit.

In accordance with another exemplary embodiment of the present invention, an intake air system for an internal combustion engine is provided. The intake air system includes a turbocharger comprising a turbine and a compressor, the turbine comprising a turbine wheel attached to a turbine shaft, the turbine wheel and shaft rotatably disposed in a turbine housing, the turbine housing comprising a turbine volute conduit, the turbine volute conduit, having a turbine volute inlet and a wastegate/EGR conduit inlet, the wastegate/EGR conduit inlet radially spaced from the turbine volute inlet along the turbine volute conduit and opening into an EGR conduit that is joined to the turbine volute conduit. The turbine volute inlet is configured for fluid communication of an exhaust gas received from an engine to the turbine wheel, the wastegate/EGR conduit is configured for fluid communication of the exhaust gas to an engine intake conduit. The compressor comprising a compressor wheel attached to the turbine shaft, the compressor wheel and turbine shaft rotatably disposed in compressor housing, the compressor comprising a compressor volute conduit, the compressor volute conduit having a compressor volute inlet, a compressor volute outlet, the compressor volute outlet in fluid communication with the engine intake conduit. The intake air system also includes an EGR valve switchable between at least an open and a closed position and having an EGR valve inlet and an EGR valve outlet, the EGR valve inlet in fluid communication with the EGR conduit, the EGR valve outlet also in fluid communication with the engine intake conduit, the open position in a blank fluid communication from the EGR conduit to the engine intake conduit and defining a first operating mode, in the closed position disabling fluid communication from the EGR conduit to the engine intake conduit and defining a second operating mode, wherein the in the first mode an EGR gas flow from the EGR conduit is promoted within the engine intake conduit and in the second mode of pressurized airflow is promoted within the engine intake conduit.

In accordance with yet another exemplary embodiment of the present invention, a method of using an intake air system for an internal combustion engine is provided. The method includes providing an internal combustion engine having a turbocharger in fluid communication with an intake manifold of the engine and configured to provide a forced-induction airflow thereto having a first pressure, the turbocharger comprising a turbine housing, the turbine housing comprising a turbine volute conduit, the turbine volute conduit having a turbine volute inlet and a wastegate/EGR conduit inlet, the wastegate/EGR conduit inlet radially spaced from the volute inlet along the turbine volute conduit and opening into an EGR conduit that is disposed on the turbine housing, the EGR conduit configured for fluid communication of an EGR flow to an EGR valve switchable between an open and a closed position, the open position enabling fluid communication of the EGR flow having a second pressure to the intake manifold and defining a first operating mode, and the closed position disabling fluid communication from the EGR conduit to the intake manifold and defining a second operating mode, wherein in the first mode the second pressure is greater than the first pressure and an EGR flow to the engine is promoted within the intake manifold. The method also includes operating the engine to produce an exhaust gas flow into the turbine volute inlet. The method also includes selecting the first mode or the second mode while operating the engine.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

Other objects, features, advantages and details appear, by way of example only, in the following detailed description of embodiments, the detailed description referring to the drawings in which:

FIG. 1 is a schematic view of an exemplary embodiment of a forced-induction intake air system as disclosed herein;

FIG. 2 is a front view of an exemplary embodiment of a turbine housing for a turbocharger, as disclosed herein;

FIG. 3 is a perspective view of the turbine housing of FIG. 2,

FIG. 4 is a top view of the turbine housing of FIG. 2 and an exemplary embodiment of a turbocharger incorporating the same as disclosed herein;

FIG. 5 is a side view of the turbine housing and turbocharger of FIG. 4;

FIG. 6 is a cross-sectional view of the turbine housing of FIG. 5 taken along section 6-6; and

FIG. 7 is a cross-sectional view of the turbine housing of FIG. 2 taken along section 7-7;

FIG. 8 is a cross-sectional view of the turbine housing of FIG. 2 taken along section 8-8;

FIG. 9 is a cross-sectional view of the turbine housing of FIG. 2 taken along section 9-9; and

FIG. 10 is a flowchart of an exemplary method of using an intake air system as described herein.

### DESCRIPTION OF THE EMBODIMENTS

The present invention discloses an exemplary embodiment of a turbine housing, and exemplary embodiments of a turbocharger and air induction system for an internal combustion engine that incorporate the turbine housing, as well as associated methods of their use, that enhance EGR available for use in the air induction system while at the same time providing sufficient exhaust gas flow to drive the turbine and generate the desired pressure boost and induction airflow into the air intake system, regardless of whether the turbocharger uses a fixed or variable nozzle turbine.

The present invention includes a turbine housing having a wastegate-like conduit or passage which directly bypasses or shunts a portion of the exhaust gas energy from the turbine wheel and reduces the effective efficiency of the turbine stage, which consequently reduces the boost pressure of the intake airflow available from the compressor and allows for EGR flow pressures which are higher than the intake airflow pressures, thus promoting the EGR flow to enter and be intermixed with the intake airflow to produce a combustion airflow that includes EGR, including a predetermined amount or flow of EGR.

A wastegate or EGR conduit inlet is located in the turbine volute and an associated EGR conduit is integrally formed in the turbine housing with a connection to the EGR system such that the EGR valve also effectively serves as a wastegate valve. In this instance; however, the term wastegate is somewhat of a misnomer, since the exhaust shunted through the “wastegate” is in fact available for use as EGR flow. What would otherwise normally be wastegate flow and would bypass the turbine volute and turbine wheel altogether to be exhausted from the vehicle through its exhaust system is instead passed into the turbine volute conduit, where a portion is available for use as desirable EGR flow while the remaining portion may be used to drive the turbine wheel, albeit at a reduced efficiency relative to that which would be available from the entire exhaust flow. The wastegate may be associated with the EGR conduit or flow passage in the form of an EGR valve attached to the EGR conduit, including both two-position (fully open and closed) and variable position EGR valves, such that the EGR valve serves as a wastegate valve and the action of opening the EGR valve also opens the wastegate. When EGR flow is desired to support the combustion process, the engine control system opens the EGR valve. Opening the EGR valve simultaneously reduces turbine efficiency and promotes EGR flow. This synergistic interaction to promote EGR flow is an advantageous aspect of the turbine housing disclosed herein, as well as turbochargers and intake air systems that incorporate them. This synergistic arrangement enables incorporation of a wastegate function while also enabling integrated balancing of the EGR flow and forced-induction intake airflow requirements.

The present invention enhances EGR available for use in the induction system, while at the same time providing sufficient exhaust flow to drive the turbine and generate the desired pressure boost and air induction into the air intake system, and effectively resolves the issue of inhibited EGR flow due to excessive turbine boost by directly reducing the turbine efficiency by “wastegating” exhaust flow directly from within the turbine volute when necessary as EGR flow. This reduces the total energy available in the exhaust stream to drive the turbine wheel and compressor wheel, thereby reducing the turbine efficiency and boost pressure. This may be used, for example, to prevent the development of undesirable intake air boost pressures, particularly those that result from the use of variable nozzle turbines to increase backpressures, which are intended to promote EGR flow, but which actually generate increases in the boost pressures that offset gains in the EGR flow, thereby preventing EGR flow into the forced-induction intake airflow. While the invention is particularly useful in conjunction with variable nozzle turbines (VNT's), the devices and methods disclosed can be used with both (VNT) and fixed nozzle turbines. The present invention enables the controlled, repeatable, and temporary reduction of the turbocharger efficiency while at the same time promoting EGR flow in the combustion air mixture.

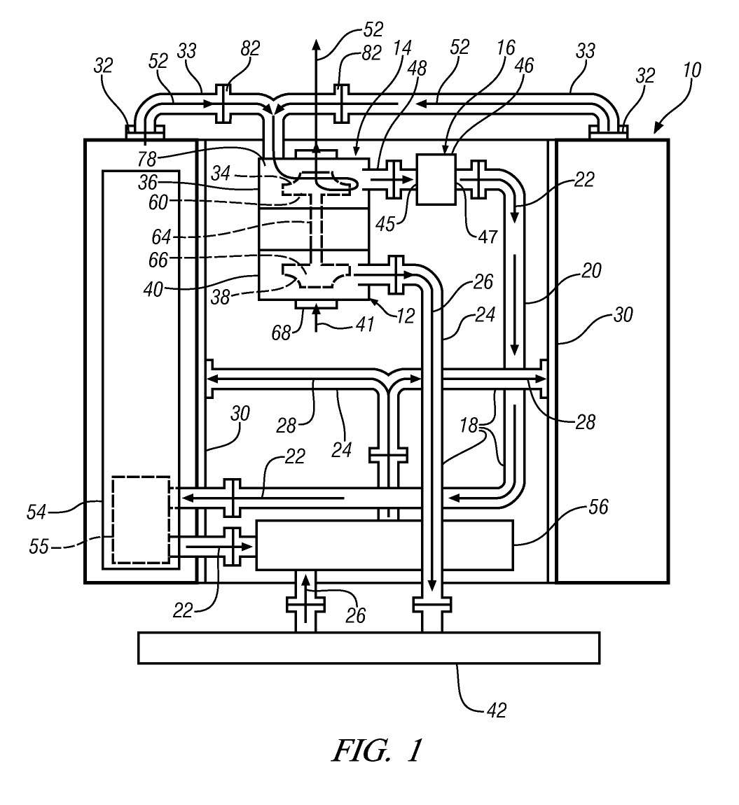

As illustrated in FIG. 1, in accordance with an exemplary embodiment of the present invention an internal combustion engine 10 includes a forced-induction system 12, including turbocharger 14, and an EGR system 16 that respectively supply intake air or EGR, or a combination or mixture thereof, to air intake system 18. Air intake system 18 includes EGR intake conduit 20 configured for fluid communication of a pressurized or forced-induction EGR flow represented by arrow 22 and engine intake conduit 24 configured for fluid communication of a pressurized, forced-induction airflow represented by arrow 26. EGR flow 22 and airflow 26 are used to make up the pressurized or forced-induction combustion flow 28 that provides pressurized, forced-induction air or EGR, or a combination or mixture thereof, to engine 10 for combustion. Air intake system 18 also includes an intake manifold 30, or plurality of manifolds, that receives combustion flow 28 and distributes the combustion flow 28 to the engine cylinders (not shown). Air intake system 18 may also, optionally, include other intake system devices downstream of EGR intake conduit 20 and engine intake conduit 24 and upstream of intake manifold 30, including EGR flow 22 and forced-induction airflow 26 coolers, as well as mixers for combining these airflows, as described herein.

Referring to FIG. 1, engine 10 includes intake manifold 30, or a plurality of manifolds, and an exhaust manifold 32, or a plurality of manifolds 32. Engine 10 also includes a turbocharger 14 that includes a turbine 34 contained in a turbine housing 36 and a compressor 38 contained in a compressor housing 40, for compressing ambient intake air illustrated by arrow 41 and producing the pressurized, forced-induction airflow 26 for combustion in engine 10. Intake airflow 41 is heated during the turbocharger compression process and may be cooled to improve their volumetric efficiency by increasing intake air charge density through isochoric cooling. That cooling may be accomplished by routing the forced-induction airflow 26 discharged from the turbocharger 14 to a turbocharger air cooler 42, which may also be referred to as an inter cooler or after cooler, via engine intake conduits 24. Turbocharger air cooler 42 may be engine mounted. The forced-induction air flow 26 is then routed from the turbocharger air cooler 42 through engine intake conduit 24 and intake manifold 30 for distribution to the cylinders of engine 10.

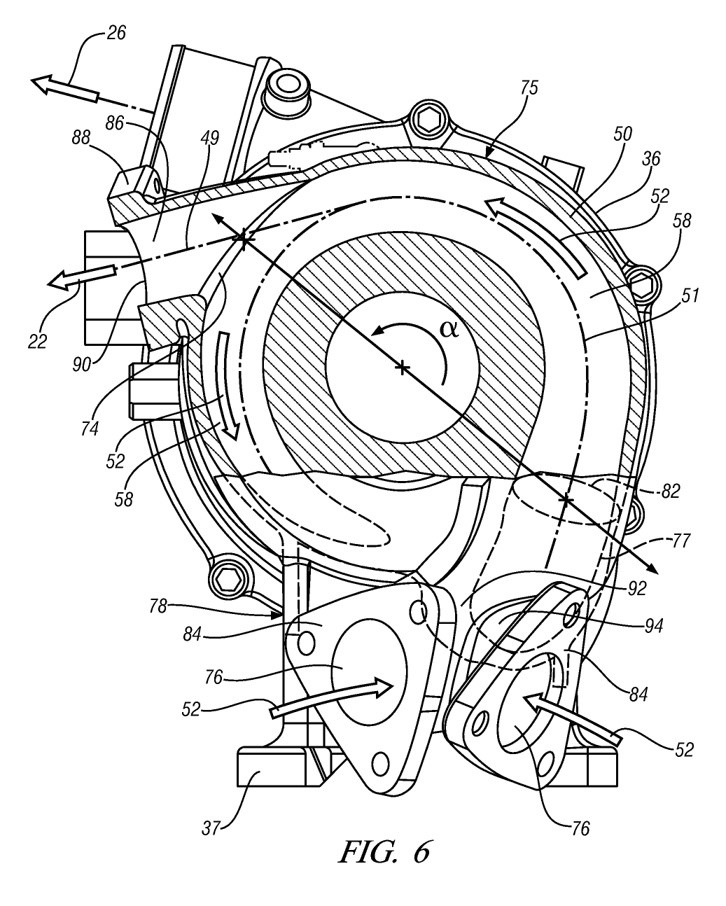

Engine 10 and forced-induction system 12 also includes an EGR system 16. EGR system 16 includes an EGR control valve 46. EGR control valve 46 is in fluid communication with and regulates the release of exhaust gas as EGR from the turbine housing 36 through EGR conduit 48, as further explained herein. EGR control valve 46 acts as a wastegate and is configured to divert a portion of the exhaust gas flow 52 from the exhaust manifold 32 and associated conduits 33, that would otherwise pass through turbine housing 36 via turbine volute conduit 50 (See FIG. 6), for use as EGR flow 22 through EGR conduit 48. EGR flow 22 exits EGR conduit 48 through EGR conduit outlet 90 (FIG. 6) where it is routed to EGR control valve 46 as part of EGR system 16. By controlled opening and closing of the valve, EGR flow 22 is mixed with the forced-induction airflow 26 in intake charge mixer 56. EGR system 16 may also include an EGR cooler 54, or heat exchanger, that may also be engine-mounted for cooling the EGR flow 22 passing through the system. By providing a heat exchanger in the EGR system 16, EGR cooler 54 may also provide for increased efficiency of engine 10. EGR cooler 54 may also include a bypass valve 55 that permits the EGR flow 22 to bypass the cooler during periods when cooling is not needed or desirable, such as at cold engine startup. The EGR flow 22 passing through or bypassing EGR cooler 54 is combined with the forced-induction airflow 26 that has in turn passed through the turbocharger air cooler 42 to provide force-induction combustion (air or air+EGR) flow 28. The gas flows 22 and 26 may be combined using intake charge mixer 56 to improve the homogeneity of the combustion flow 28 before the flow enters the intake manifold 30 of the engine 10. Forced induction system 12 may be operated without affecting the efficiency of turbocharger 14 when EGR control valve 46 is closed, and forced induction combustion flow 28 includes just forced-induction airflow 26. When EGR control valve 46 is opened, the efficiency of turbine 34 and turbocharger 14 is reduced, thereby promoting introduction of EGR flow 22 into forced-induction combustion flow 28 so that flow 28 includes a mixture of forced-induction airflow 26 and EGR flow 28, as described herein. By using a variable EGR control valve 46, the reduction of efficiency of turbocharger 14 and the mixture of forced-induction airflow 26 and EGR flow 28 can be controlled.

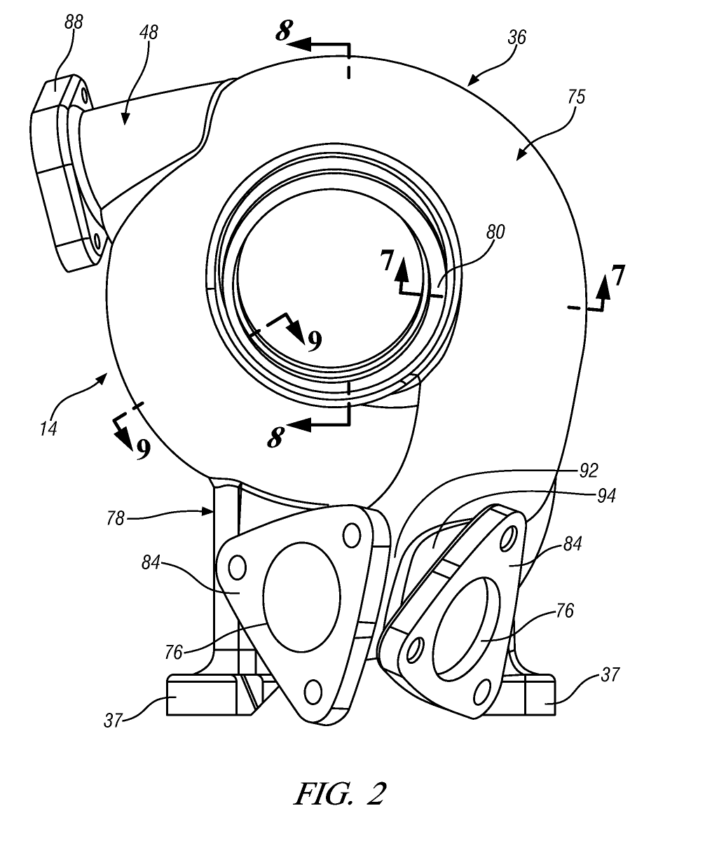

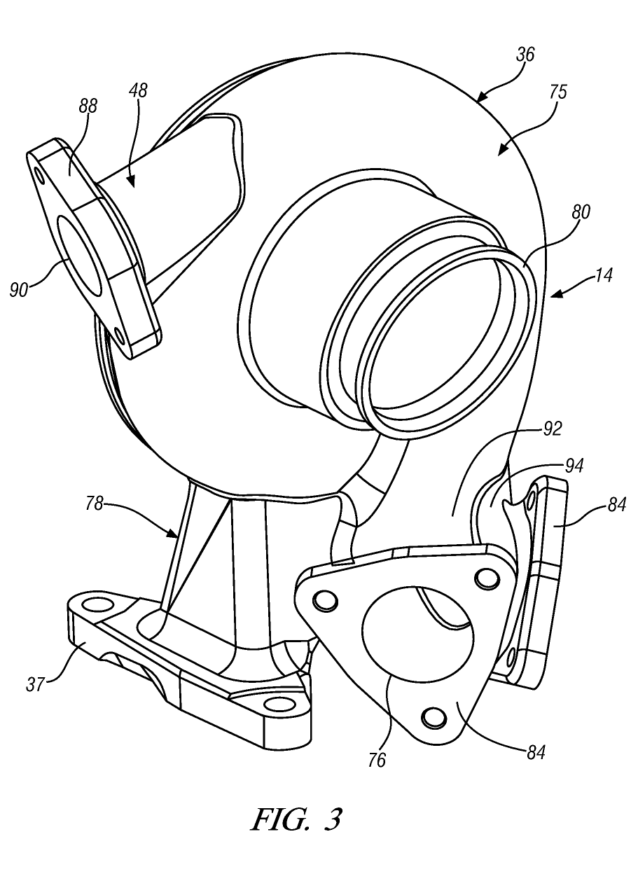

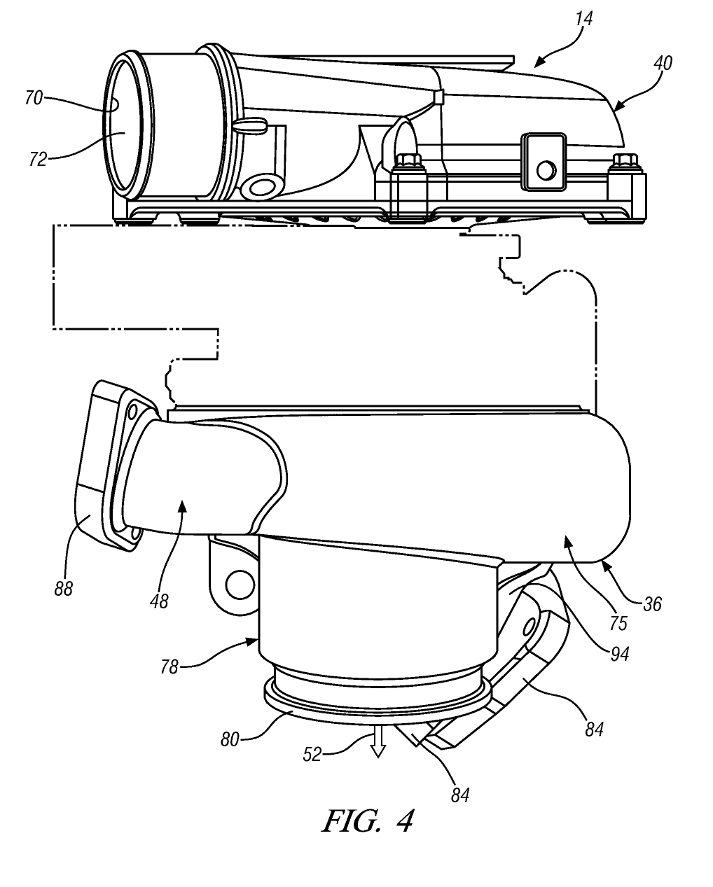

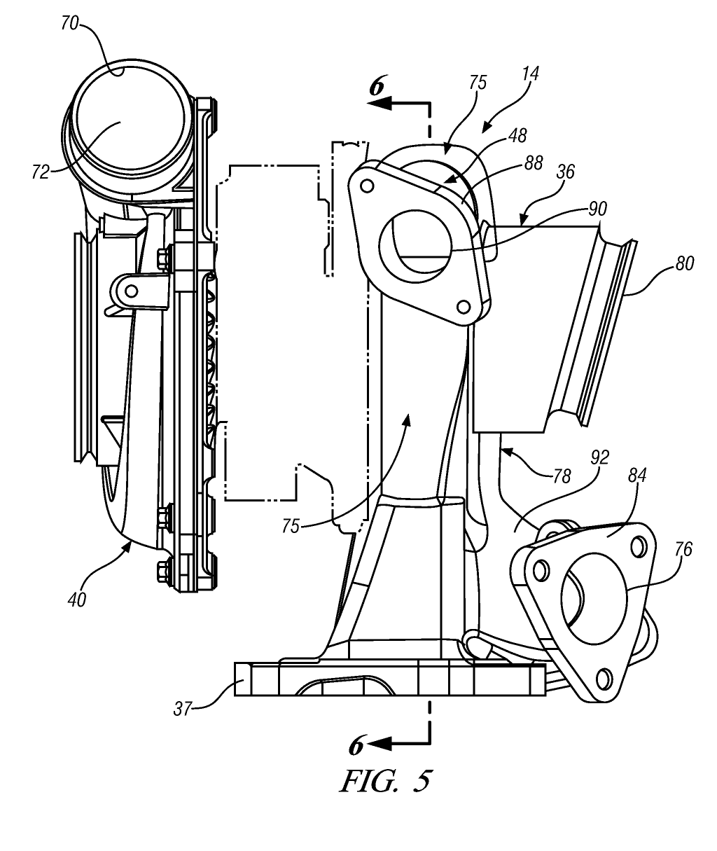

FIGS. 1-9 show an exemplary embodiment of a turbine housing 36, and turbocharger 14 that uses the housing, in greater detail. Turbine housing 36 may include one or more mounting flanges 37 for mounting the housing to the engine 10. Turbine housing 36 includes one or more turbine inlets 76, a housing body 78 that includes a turbine volute 75 that defines the turbine volute conduit 50 and associated turbine volute passage 58 and the turbine outlet 80. Housing 36 also includes an EGR conduit inlet 74 that is radially spaced away from the turbine volute inlet 82 along the turbine volute conduit 50.

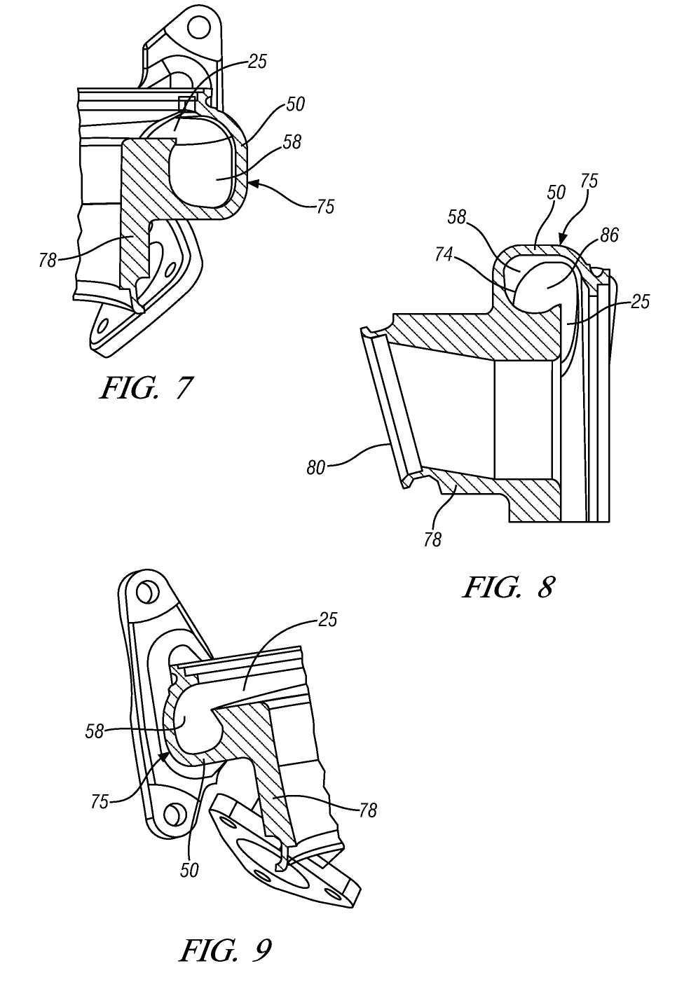

Referring to FIGS. 1-6, turbine housing inlets 76 may be attached directly to the exhaust manifold 32, or a plurality of manifolds, of the engine 10, or maybe attached indirectly through additional exhaust conduits (not shown). The one or more turbine inlets 76 may be associated with one or more branches 92, 94 of inlet conduit 77. For example, in the embodiment of FIGS. 1-6, there are two turbine inlets 76 and two respective branches 92, 94 that merge into a single inlet conduit 77. Turbine housing inlets 76 may be incorporated into one or more mounting flanges 84 for detachable attachment, as described, using a plurality of threaded bolts, clamps or the like (not shown). Exhaust gas flows 52 (FIG. 6) entering the turbine housing inlet 76 are combined into a single exhaust gas flow 52 that flows into turbine volute conduit 50 at turbine volute inlet 82. Referring to FIG. 6, turbine volute conduit 50 has an inwardly curving and converging turbine volute passage 58, such as a spiroidal-shaped curving passage. As turbine volute passage 58 converges away from turbine volute inlet 82, as shown in FIGS. 7-9, the cross-sectional area of the passage is progressively reduced. The progressive reduction of turbine volute passage 58 progressively increases the speed of exhaust gas flow 52 within the passage. The turbine volute conduit 50 spirals inwardly about turbine wheel 60, which is in fluid communication with conduit 50 and turbine volute passage 58 through circumferentially extending turbine nozzle 25. Nozzle 25 directs exhaust gas flow 52 across turbine blades (not shown) on turbine wheel 60 where it is exhausted through turbine conduit outlet 80, thereby causing rotation of turbine wheel 60 and turbine shaft 64 to which it is attached, which in turn rotates the compressor wheel 66 that is attached to the opposite end of shaft 64. Rotation of the compressor wheel 66 draws air into the compressor intake 68 which is then compressed as it passes through the compressor nozzle (not shown) and expelled through compressor volute conduit 70 and compressor volute conduit outlet 72 as forced-induction airflow 26.

Referring to FIGS. 1 and 6-9, EGR conduit inlet 74 opens into EGR conduit 48 that is disposed on turbine housing 36 over the EGR conduit inlet 74. In the exemplary embodiment of FIG. 6, EGR conduit 48 is disposed over EGR conduit inlet and extends tangentially outwardly from turbine volute 75 as an integral portion of turbine housing 36. EGR conduit 48 has an EGR conduit passage 86. EGR conduit 48 may have a substantially similar size and shape, or cross-sectional area, as EGR conduit inlet 74 so that a smooth transition occurs between turbine conduit 50 and EGR conduit 48. Alternately, EGR conduit 48 may have a cross-sectional area that is less than the cross-sectional area of EGR conduit inlet 74. EGR conduit passage 86 and EGR conduit inlet 74 may have any suitable cross-sectional area and orientation with respect to the turbine volute conduit 50 and turbine volute passage 58 sufficient to provide a predetermined EGR flow 22, as well as a predetermined exhaust gas flow through nozzle 25, including a cross-sectional area of the EGR conduit passage 86 that is less than or equal to the cross-sectional area of the turbine volute passage 58 proximate the EGR conduit inlet 74. Further, the cross-sectional area of EGR conduit passage 86 may be the same along its length away from the EGR conduit inlet 74, or alternately, may progressively converge or diverge away from the EGR conduit inlet. In the exemplary embodiment of FIG. 6, a central axis 49 of EGR conduit 48 and EGR conduit passage 86 may be substantially tangential to and co-planar with a central axis 51 of turbine volute conduit 50 and turbine volute passage 58 in order to minimize losses in EGR flow 22. Further, in this embodiment, the cross-sectional area of EGR conduit passage 86 may be less than the cross-sectional area of the turbine volute passage 58 proximate the EGR conduit inlet to provide the predetermined EGR flow 22 and predetermined exhaust gas flow 52 through turbine nozzle 25. The EGR conduit passage 86 and turbine volute passage 58 should be sized to obtain a predetermine EGR flow 22 and a reduction in the forced-induction airflow 26, wherein the pressure of EGR flow 22 is greater than the pressure of forced-induction airflow 26, thereby promoting a predetermined EGR flow 22 portion of forced-induction flow 28. EGR conduit 48 may also include a mounting flange 88 proximate EGR conduit outlet 90 for detachable attachment to EGR intake conduit 20, as described herein, using a plurality of threaded bolts, clamps or the like (not shown).

EGR conduit inlet 74 is radially spaced away from the turbine volute inlet 82 along turbine volute conduit 50. The radial spacing may be characterized as an angle (α) between the centers of EGR conduit inlet 74 and turbine volute inlet 82 (FIG. 6). In an exemplary embodiment, the spacing may be between about 80° to about 270°. As the radial spacing (a) increases, the speed of exhaust gas flow 52 within turbine volute passage 58 increases, hence the speed of EGR flow 22 also increases, when EGR control valve 46 is opened. As described herein, the opening of EGR control valve 46 also reduces exhaust gas flow 52 within turbine volute conduit 50, thereby reducing the amount of work done by exhaust gas flow 52 on turbine wheel 60 and a concomitant reduction of the work that may be performed by compressor wheel 66, thereby lowering the pressure or boost available from the turbocharger. As described, the balance of increasing the EGR flow 22 pressure and reducing the forced-induction airflow 26 may be used to increase the amount of EGR available in forced-induction combustion flow 28 and provide a predetermined amount of EGR in forced-induction combustion flow 28. The radial spacing, orientation, size and other aspects of EGR conduit 48 and EGR conduit inlet 74 may be used to control the predetermined amount of EGR in forced-induction combustion flow 28.

In the exemplary embodiment of FIGS. 1-9, the turbine nozzle 25 is a fixed geometry nozzle. In another exemplary embodiment, turbine nozzle 25 may be a variable geometry nozzle. The nozzle geometry may be varied to control back pressure in the turbine volute passage and associated upstream conduits, including the exhaust manifold, wherein reducing the nozzle opening increases backpressure and increasing the nozzle opening reduces backpressure. The nozzle geometry and backpressure may be controlled by various actuator mechanisms.

Turbine housing 36 and the portions thereof described above may be made individually, in any combination, and assembled together to make turbine housing. Alternately, turbine housing 36, as described herein, may be formed as an integral whole, such as by casting the housing. Suitable materials for use as turbine housing 36 include various grades and alloys of cast iron and steel. Further, housing may receive any suitable secondary finishing operation, including cleaning, machining and the like.

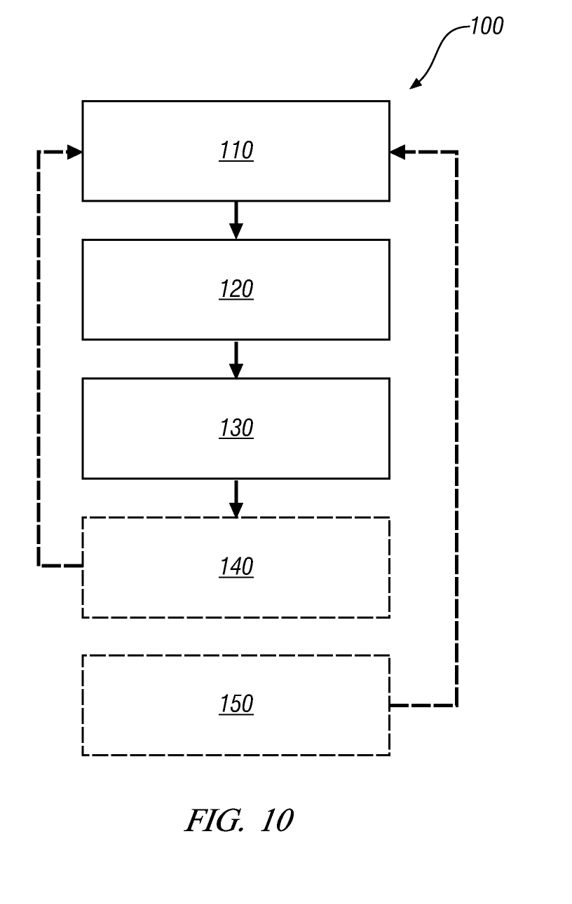

Referring to FIGS. 1-10, in accordance with yet another exemplary embodiment of the present invention, a method 100 of using an intake air system 18 for an internal combustion engine 10 is provided. Method 100 includes providing 110 an internal combustion engine 10 having a turbocharger 14 in fluid communication with an intake manifold 30 of the engine and configured to provide a forced-induction airflow 26 thereto having a first pressure. The turbocharger 14 includes a turbine housing 36 that includes turbine volute conduit 50. Turbine volute conduit 50 has a turbine volute inlet 82 and an EGR conduit inlet 74 that is radially spaced from the volute inlet along the turbine volute conduit and opens into an EGR conduit 48 that is disposed on the turbine housing 36. The EGR conduit 48 is configured for fluid communication of EGR flow 22 to an EGR control valve 46 that is switchable between an open and a closed position. EGR flow 22 is received at EGR control valve 46 through EGR valve inlet 45. The open position of EGR control valve 46 enables fluid communication of EGR flow 22, having a second pressure, through EGR valve outlet 47 to the intake manifold 30 and defines a first operating mode. The closed position disables fluid communication from the EGR conduit 48 to the intake manifold 30 and defines a second operating mode. In the first mode, the second pressure is greater than the first pressure and EGR flow 22 to the engine is promoted within the intake manifold 30. Method 100 also includes operating 120 the engine 10 to produce exhaust gas flow 52 in the turbine volute conduit 50 at turbine volute inlet 82. Method 100 also includes selecting 130 the first mode or the second mode while operating the engine. Selecting 130 may be performed using a suitable controller (not shown), such as an engine control unit (ECU). In the first mode, the efficiency of the turbocharger and the first pressure are reduced in conjunction with providing the EGR flow 22 to the intake manifold 30. Optionally, method 100 also includes selecting 140 the radial spacing of the turbine volute inlet 82 and EGR conduit inlet 74 to obtain a predetermined EGR flow 22, as described herein. Optionally, the EGR control valve 46 is a variable EGR control valve 46 switchable between the open position, the closed position and a plurality of partially open positions therebetween that define a corresponding plurality of operating modes, wherein the method further comprises selecting 150 one of the plurality of operating modes, and wherein in the first operating mode and the plurality of operating modes, the second pressure is greater than the first pressure, thereby promoting a corresponding plurality of EGR flows into the intake manifold 30.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. A turbocharger, comprising:
a turbine comprising a turbine wheel attached to a turbine shaft, the turbine wheel and shaft rotatably disposed in a turbine housing having a turbine volute conduit, the turbine volute conduit having a turbine volute inlet and an EGR conduit inlet, the EGR conduit inlet radially spaced from the turbine volute inlet along the turbine volute conduit and opening into an EGR conduit that is joined to the turbine volute conduit, the turbine volute inlet configured for fluid communication of an exhaust gas received from an engine to the turbine wheel, the EGR conduit configured for fluid communication of the exhaust gas to an engine intake conduit.

2. The turbocharger of claim 1, wherein the EGR conduit has an EGR conduit axis and the turbine volute conduit has a turbine volute conduit axis, and the EGR conduit axis is disposed substantially tangentially to the turbine volute conduit axis.

3. The turbocharger of claim 1, wherein the EGR conduit inlet is radially spaced from the turbine volute inlet by an angle α of about 80° to about 270°.

4. The turbocharger of claim 1, wherein the EGR conduit has a cross-sectional area that is substantially the same as a cross-sectional area of the turbine volute conduit proximate the EGR conduit inlet.

5. The turbocharger of claim 1, wherein the EGR conduit has a cross-sectional area that is less than a cross-sectional area of the turbine volute conduit proximate the EGR conduit inlet.

6. The turbocharger of claim 1, wherein the volute conduit and EGR conduit comprise an integral component.

7. The turbocharger of claim 6, wherein the integral component comprises a metal casting.

8. The turbocharger of claim 1, wherein the turbine further comprises one of a fixed nozzle or a variable nozzle.

9. An intake air system for an internal combustion engine, comprising:
a turbocharger comprising a turbine and a compressor, the turbine comprising a turbine wheel attached to a turbine shaft, the turbine wheel and shaft rotatably disposed in a turbine housing, the turbine housing comprising a turbine volute conduit, the turbine volute conduit having a turbine volute inlet and an EGR conduit inlet, the EGR conduit inlet radially spaced from the turbine volute inlet along the turbine volute conduit and opening into an EGR conduit that is disposed on the turbine housing, the turbine volute inlet configured for fluid communication of an exhaust gas flow received from an engine to the turbine wheel, the EGR conduit configured for fluid communication of a portion of the exhaust gas flow to an engine intake manifold, the compressor comprising a compressor wheel attached to the turbine shaft, the compressor wheel and turbine shaft rotatably disposed in a compressor housing, the compressor housing comprising a compressor volute conduit, the compressor volute conduit having a compressor volute inlet and a compressor volute outlet, the compressor volute outlet in fluid communication with the engine intake manifold;
an EGR valve switchable between at least an open and a closed position and having an EGR valve inlet and an EGR valve outlet, the EGR valve inlet in fluid communication with the EGR conduit, the EGR valve outlet also in fluid communication with the engine intake manifold, the open position enabling fluid communication from the EGR conduit to the engine intake manifold and defining a first operating mode, and the closed position disabling fluid communication from the EGR conduit to the engine intake manifold and defining a second operating mode, wherein in the first mode an EGR gas flow from the EGR conduit is promoted within the engine intake manifold.

10. The intake air system of claim 9, further comprising a mixer, wherein the mixer is in fluid communication with the EGR valve, and configured to receive the EGR flow therefrom, and the compressor, and is configured to receive a forced-induction airflow therefrom, and wherein the mixer is in fluid communication with the intake manifold and is configured to receive a mixture of the EGR flow and forced-induction airflow as a forced-induction combustion flow therefrom.

11. The intake air system of claim 9, wherein the EGR conduit inlet is radially spaced from the volute inlet by an angle α of about 80° to about 270°.

12. The intake air system of claim 9, wherein the EGR conduit inlet has a cross-sectional area that is substantially the same as a cross-sectional area of the turbine volute conduit proximate the EGR conduit inlet.

13. The intake air system of claim 9, wherein the EGR conduit inlet has a cross-sectional area that is less than a cross-sectional area of the turbine volute conduit proximate the EGR conduit inlet.

14. The intake air system of claim 9, further comprising an internal combustion engine having an exhaust port, wherein the turbine volute inlet is in fluid communication with the exhaust port.

15. The intake air system of claim 9, wherein the EGR valve is a variable valve switchable between a plurality of positions.

16. The intake air system of claim 9, wherein the turbine further comprises one of a variable nozzle or a fixed nozzle.

17. A method of using an intake air system for an internal combustion engine, comprising:
providing an internal combustion engine having a turbocharger in fluid communication with an intake manifold of the engine and configured to provide a forced-induction airflow thereto having a first pressure, the turbocharger comprising a turbine housing, the turbine housing comprising a turbine volute conduit, the turbine volute conduit having a turbine volute inlet and an EGR conduit inlet, the EGR conduit inlet radially spaced from the volute inlet along the turbine volute conduit and opening into an EGR conduit that is disposed on the turbine housing, the EGR conduit configured for fluid communication of an EGR flow to an EGR valve switchable between an open and a closed position, the open position enabling fluid communication of the EGR flow having a second pressure to the intake manifold and defining a first operating mode, and the closed position disabling fluid communication from the EGR conduit to the intake manifold and defining a second operating mode, wherein in the first mode the second pressure is greater than the first pressure and an EGR flow to the engine is promoted within the intake manifold.
operating the engine to produce an exhaust gas flow into the turbine volute inlet; and
selecting the first mode or the second mode while operating the engine.

18. The method of claim 17, further comprising selecting the radial spacing of the turbine volute inlet and the EGR conduit inlet to obtain a predetermined EGR flow.

19. The method of claim 17, wherein the EGR valve is a variable EGR valve switchable between the open position, the closed position and a plurality of partially open positions therebetween that define a corresponding plurality of operating modes, and wherein the method further comprises selecting one of the plurality of operating modes, and wherein in the first operating mode and the plurality of operating modes, the second pressure is greater than the first pressure, thereby promoting a corresponding plurality of EGR flows into the engine intake conduit.

20. The method of claim 17, wherein in the first mode, the efficiency of the turbocharger is compromised and the first pressure is reduced in conjunction with providing the EGR flow to the intake manifold.
